(19) United States
(12) Patent Application Publication
(10) Pub. No.: US 2026/0368904 A1
(43) Pub. Date: Nov. 19, 2026

(54) MEDICAL IMAGE PROCESSING APPARATUS, MEDICAL IMAGE PROCESSING METHOD, AND NON-TRANSITORY COMPUTER READABLE MEDIUM

(71) Applicant: CANON KABUSHIKI KAISHA, Tokyo (JP)

(72) Inventor: ITARU OTOMARU, Kanagawa (JP)

(21) Appl. No.: 19/669,159

(22) Filed: May 6, 2026

(30) Foreign Application Priority Data
May 19, 2025 (JP) 2025-083343

(51) Int. Cl. G06T 7/12; G06T 7/00; G06T 7/73; G06T 11/00

(52) U.S. Cl. CPC G06T 7/12; G06T 7/0014; G06T 7/74; G06T 11/00; G06T 2207/10132; G06T 2207/20084; G06T 2207/30048

(57) ABSTRACT

A medical image processing apparatus, includes a processor, and a memory storing a program which, when executed by the processor, causes the medical image processing apparatus to execute image acquisition processing of acquiring a medical image representing a first anatomical site, at least a part of which is outside of a rendered range, and execute complementary information acquisition processing of acquiring complementary information with respect to an object region including a portion outside of the rendered range, based on information regarding a second anatomical site, a rendered position of which differs spatially or temporally from a rendered position of the first anatomical site.

### BACKGROUND

### Field of the Technology

The present disclosure relates to a medical image processing apparatus, a medical image processing method, and a non-transitory computer readable medium.

### Description of the Related Art

In medical imaging, in a case where an object to be observed is not included in an image signal reconstruction region and is cut off from the medical image, there is a technique available to improve estimation accuracy of information about the object (such as a region and anatomical landmarks of the object).

For example, Japanese Patent Laid-Open No. 2007-513649 discloses a technique for eliminating an effect of an object that is obscured by an invalid data region in images containing such a region. In addition, Chenfei Wu, et al. “NUWA-Infinity: Autoregressive over Autoregressive Generation for Infinite Visual Synthesis” discloses a technique that uses a learned model to complement a designated region of an input image.

However, in the related art described above, when complementing an image in a region outside of a signal reconstruction region, an image of a region to be complemented may not be appropriately complemented if prior information regarding the object region (for example, types and ranges of objects that exist in the region) is unknown.

### SUMMARY

The technique according to the present disclosure improves complementary accuracy of an object in an image in which a part of the object is cut off.

According to some embodiments, a medical image processing apparatus includes a processor, and a memory storing a program which, when executed by the processor, causes the medical image processing apparatus to execute image acquisition processing of acquiring a medical image representing a first anatomical site, at least a part of which is outside of a rendered range, and execute complementary information acquisition processing of acquiring complementary information with respect to an object region including a portion outside of the rendered range, based on information regarding a second anatomical site, a rendered position of which differs spatially or temporally from a rendered position of the first anatomical site.

According to some embodiments, a medical image processing method includes acquiring a medical image representing a first anatomical site, at least a part of which is outside of a rendered range, and acquiring complementary information with respect to an object region including a portion outside of the rendered range, based on information regarding a second anatomical site, a rendered position of which differs spatially or temporally from a rendered position of the first anatomical site.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram showing a configuration example of a medical image processing apparatus according to a first embodiment.

FIG. 2 is a flow chart of processing executed by the medical image processing apparatus according to the first embodiment.

FIGS. 3A to 3C are diagrams schematically showing complementary estimation with respect to an echocardiogram in the first embodiment.

FIG. 4 is a block diagram showing a configuration example of a medical image processing apparatus according to a second embodiment.

FIG. 5 is a flow chart of processing executed by the medical image processing apparatus according to the second embodiment.

### DESCRIPTION OF THE EMBODIMENTS

Hereinafter, embodiments of the medical image processing apparatus according to the present disclosure will be described in detail with reference to the accompanying drawings. However, the components described in the following embodiments are merely illustrative, and the technical scope of the present disclosure is to be defined by the claims and is not limited to the specific embodiments described below.

### First Embodiment

Hereinafter, a medical image processing apparatus (hereinafter, referred to as an image processing apparatus) according to a first embodiment will be described. The image processing apparatus according to the present embodiment acquires information regarding an object (hereinafter, referred to as object 1) within a signal reconstruction region to be an object of signal reconstruction processing in an input image. In addition, the image processing apparatus complementarily estimates an image of a region where an object (hereinafter, referred to as object 2) other than object 1 exists outside of the signal reconstruction region. Furthermore, the image processing apparatus estimates information regarding object 2 using the complementarily-estimated image.

In the present embodiment, the image processing apparatus receives a B-mode image of a two-dimensional echocardiogram captured during a cardiac examination (echocardiography) by an ultrasonic diagnostic apparatus as an input image, and acquires information regarding a contour of the right ventricle that exists within a signal reconstruction region in the input image. In addition, the image processing apparatus complementarily estimates an image of a region of the left ventricle that exists outside the signal reconstruction region based on the acquired information. Furthermore, the image processing apparatus estimates a contour of the left ventricle based on the complementarily-estimated image.

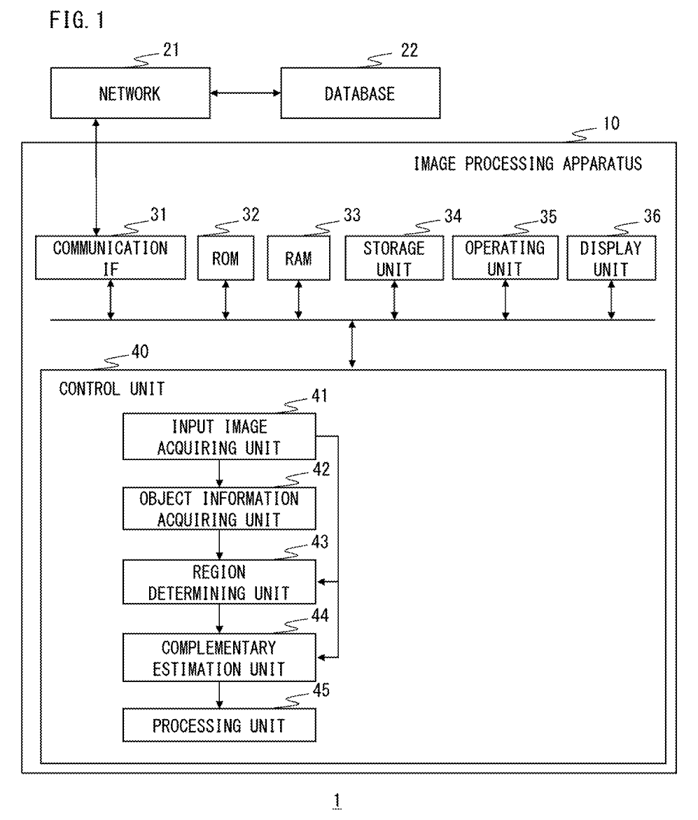

Hereinafter, a configuration and processing of the image processing apparatus according to the present embodiment will be described with reference to FIG. 1. FIG. 1 is a block diagram showing a configuration example of an image processing system (also referred to as a medical image processing system) 1 including an image processing apparatus 10 according to the present embodiment. The image processing system 1 includes the image processing apparatus 10 and a database 22.

The image processing apparatus 10 is communicatively connected to the database 22 via a network 21. For example, the network 21 includes a local area network (LAN) or a wide area network (WAN).

The database 22 stores and manages pluralities of images and pieces of information. Information managed by the database 22 includes input images acquired by the image processing apparatus 10 and object information acquired by an object information acquiring unit 42 to be described later. Note that the input images and the object information may be stored in an internal storage (a read only memory (ROM) 32 or a storage unit 34) of the image processing apparatus 10 instead of the database 22. The image processing apparatus 10 is capable of acquiring data stored in the database 22 via the network 21.

The image processing apparatus 10 includes a communication interface (IF) 31 (communicating unit), the ROM 32, and a random access memory (RAM) 33. In addition, the image processing apparatus 10 includes the storage unit 34, an operating unit 35, a display unit 36, and a control unit 40.

The communication IF 31 is a communicating unit that is constituted of a LAN card or the like and realizes communication between an external apparatus (for example, the database 22) and the image processing apparatus 10. The ROM 32 is constituted of a nonvolatile memory or the like and stores various programs and various pieces of data for realizing processing executed by the image processing apparatus 10 to be described later. The RAM 33 is constituted of a volatile memory or the like and is used as a work memory that temporarily stores running programs and data.

The storage unit 34 is constituted of a hard disk drive (HDD) or the like and stores various programs and various pieces of data. The operating unit 35 is constituted of a keyboard, a mouse, a touch panel, or the like and inputs instructions from a user (for example, a physician or a medical technologist) into various apparatuses. The display unit 36 is constituted of a display or the like and displays various kinds of information generated by the processing in the present embodiment to the user.

The control unit 40 is constituted of a central processing unit (CPU) or a dedicated or general-purpose processor. The control unit 40 may be constituted of a graphic processing unit (GPU) or a field-programmable gate array (FPGA). Alternatively, the control unit 40 may be constituted of an application-specific integrated circuit (ASIC) or the like. The control unit 40 includes an input image acquiring unit 41, the object information acquiring unit 42, a region determining unit 43, a complementary estimation unit 44, and a processing unit 45 to be described later.

The input image acquiring unit 41 acquires an image that is a processing object to be input to the image processing apparatus 10 from the database 22 or the storage unit 34. The input image may be directly acquired from a modality such as an ultrasonic diagnostic apparatus and, in such a case, the image processing apparatus 10 may be implemented as a part of the function of the modality. In the present embodiment, as one example, the left ventricle (diastole) is a first anatomical site and the input image acquiring unit 41 acquires, as the input image, a medical image representing the first anatomical site of which at least a portion is outside a rendered range.

The object information acquiring unit 42 acquires information regarding object 1 included within a signal reconstruction region in the input image acquired by the input image acquiring unit 41 from the database 22. The information regarding object 1 may be information manually input by the user or information automatically estimated with respect to the input image.

The region determining unit 43 determines, based on the information regarding object 1 acquired by the object information acquiring unit 42, an object region on which the complementary estimation unit 44 to be described later is to perform estimation processing. In the present embodiment, an existence region where object 2 extending outside of the signal reconstruction region exists is determined as a region enclosed by a rectangle. In this case, a shape of the existence region of object 2 may be a shape other than a rectangle that encloses object 2. Note that a region manually set by the user based on information regarding object 1 may be adopted as the existence region where object 2 exists.

The complementary estimation unit 44 is a complementary information acquiring unit which, with the region determined by the region determining unit 43 as an object, complementarily estimates an image outside of the signal reconstruction region included within the region using a learned model and which acquires a complemented image having been complementarily estimated. In the present embodiment, as one example, the right ventricle is a second anatomical site rendered at a position that spatially differs from the first anatomical site while the left ventricle (systole) is a second anatomical site rendered at a position that temporally differs from the first anatomical site. Based on information regarding the second anatomical site, the complementary estimation unit 44 acquires, as complementary information, a complemented image with respect to a region including a defect region with respect to an object region including a portion outside of the rendered range and a rendered region corresponding to a portion of the medical image where the first anatomical site is rendered. Therefore, the complementary estimation unit 44 acquires relationship information representing a spatial or temporal positional relationship between the second anatomical site and the first anatomical site as information regarding the second anatomical site. In addition, based on the relationship information, the complementary estimation unit 44 sets, as the object region, a region indicated by a rectangle including the defect region corresponding to the portion outside of the rendered range and the rendered region corresponding to the portion of the medical image where the first anatomical site is rendered. Specific processing executed by the complementary estimation unit 44 will be described later.

The processing unit 45 executes image processing or analysis processing with respect to the complemented image. Specifically, the processing unit 45 calculates information regarding object 2 based on the complementarily-estimated image acquired by the complementary estimation unit 44.

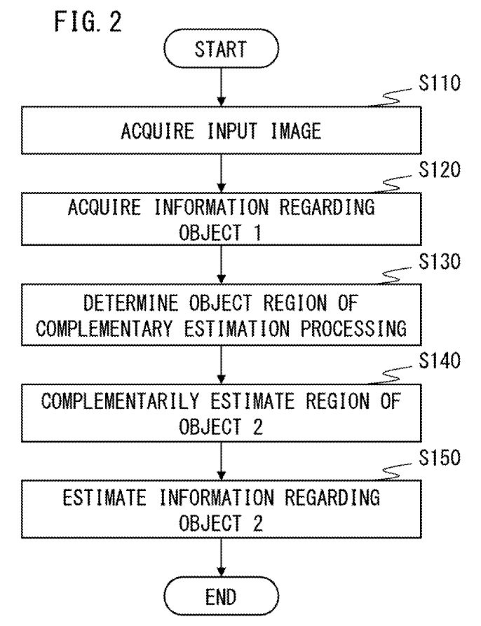

Next, an example of processing executed by the image processing apparatus 10 in the present embodiment will be described in detail with reference to the flow chart in FIG. 2.

(Step S110: Acquire Input Image) In step S110, the input image acquiring unit 41 acquires the input image designated by the user using the operating unit 35 from the database 22 and stores the acquired input image in the storage unit 34.

In the present embodiment, the input image acquiring unit 41 acquires a B-mode image of cardiac ultrasound captured by echocardiography as the input image from the database 22. The control unit 40 may display the acquired echocardiogram on the display unit 36. While the input image acquiring unit 41 acquires a two-dimensional echocardiogram in the present embodiment, the input image acquiring unit 41 may acquire a three-dimensional echocardiogram instead. In addition, while the input image acquired in the present embodiment is assumed to be a B-mode image of cardiac ultrasound, the input image is not limited to a B-mode image and may be a Doppler image or the like.

In the present step, together with the echocardiogram that is the input image, the input image acquiring unit 41 acquires a region image representing the signal reconstruction region (a binary image in which pixel values within the signal reconstruction region are set to 1 and those outside the signal reconstruction region are set to 0). Accordingly, the input image acquiring unit 41 specifies the signal reconstruction region in the input image. Note that the signal reconstruction region may be a region specified by performing edge detection with respect to the echocardiogram. Alternatively, the signal reconstruction region may be a region specified by a position of a probe and a captured region (depth or angle of signal from the probe position) within the echocardiogram, together with the echocardiogram.

(Step S120: Acquire Information Regarding Object 1) In step S120, the object information acquiring unit 42 acquires information regarding object 1 included within the signal reconstruction region in the input image acquired in step S110.

In the present embodiment, object 1 is a contour of the right ventricle and, in the present step, the object information acquiring unit 42 acquires a shape of a contour (for example, positional information of a point cloud of a contour position) included within the signal reconstruction region in the echocardiogram. Specifically, the object information acquiring unit 42 acquires the contour shape of the right ventricle in the input image using a learned model that estimates a contour shape of objects in the input image. Note that the method of acquiring a contour shape of the right ventricle by the object information acquiring unit 42 is not limited thereto and, for example, the object information acquiring unit 42 may acquire a contour shape of the right ventricle based on information manually input by the user. In addition, the control unit 40 may superimpose the acquired contour shape of the right ventricle onto the echocardiogram and display the superimposed image on the display unit 36.

While the information regarding object 1 is assumed to be information representing the region of object 1 and information in which the region of object 1 is represented by the contour shape in the present embodiment, the information regarding object 1 may be information in other forms. For example, the information regarding object 1 may be information in which the region of object 1 is represented by other forms such as a mask image (that differ from the form of the contour shape). In addition, the information regarding object 1 need not be information representing the region of object 1 as long as the information pertains to the position of object 1 and may be, for example, information of another form such as the center of gravity position of object 1 or a bounding box enclosing object 1.

(Step S130: Determine Object Region of Complementary Estimation Processing) In step S130, based on the information regarding object 1 acquired in step S120, the region determining unit 43 determines a region in the input image where object 2 is likely to exist (region likely to include object 2) as the object region of complementary estimation processing.

In the present embodiment, object 2 is the left ventricle and, in the present step, the region determining unit 43 determines a region where the left ventricle (object 2) positioned adjacent to the right ventricle (object 1) is likely to exist as the object region based on the position of the contour of the right ventricle that is object 1. More specifically, the region determining unit 43 acquires a relationship between a size (width and height) of a rectangular region enclosing the left ventricle and a size of a rectangular region enclosing the right ventricle as statistical information in advance. For example, the region determining unit 43 acquires statistical information (for example, average values) indicating how many times the width and height of the rectangular region enclosing the left ventricle are greater than those of the rectangular region enclosing the right ventricle, respectively. In addition, the region determining unit 43 calculates a rectangular region from the contour of the right ventricle acquired in step S120, and sets a rectangular region with a size calculated from the statistical information at a position in contact with the contour of the right ventricle as the region of the left ventricle.

In the present step, the region determining unit 43 may determine the object region of the complementary estimation processing using a statistical shape model. Specifically, the region determining unit 43 fits a statistical shape model representing a general positional relationship among the left ventricle, the left atrium, the right ventricle, and the right atrium to the contour of the right ventricle acquired in step S120. Accordingly, the region determining unit 43 specifies the position of the left ventricle and determines the rectangular region enclosing the left ventricle as the object region of the complementary estimation processing.

Note that the statistical shape model in this case is created based on results of a statistical analysis performed in advance with respect to sample data of contour shapes of the left ventricle, the left atrium, the right ventricle, and the right atrium in a plurality of images. For the statistical analysis, a known method such as principle component analysis (PCA) or a method such as kernel PCA or weighted PCA may be used. Alternatively, instead of a statistical shape model, a learned model (estimator) trained by machine learning that receives an image and the region of the right ventricle in the image as input to estimate a rectangular region where the left ventricle is likely to exist in the image may be used. As the learned model, a model based on a convolutional neural network (CNN), which is a type of deep learning model, may be adopted. Alternatively, as the learned model, a model based on known methods such as Vision Transformer, Random Forest, and AdaBoost may be adopted.

While a case of acquiring the rectangular region of the left ventricle that is object 2 is assumed in the present embodiment, information of a form other than a rectangular region may be acquired instead. For example, a shape of a region of the left ventricle calculated using a statistical shape model may be acquired.

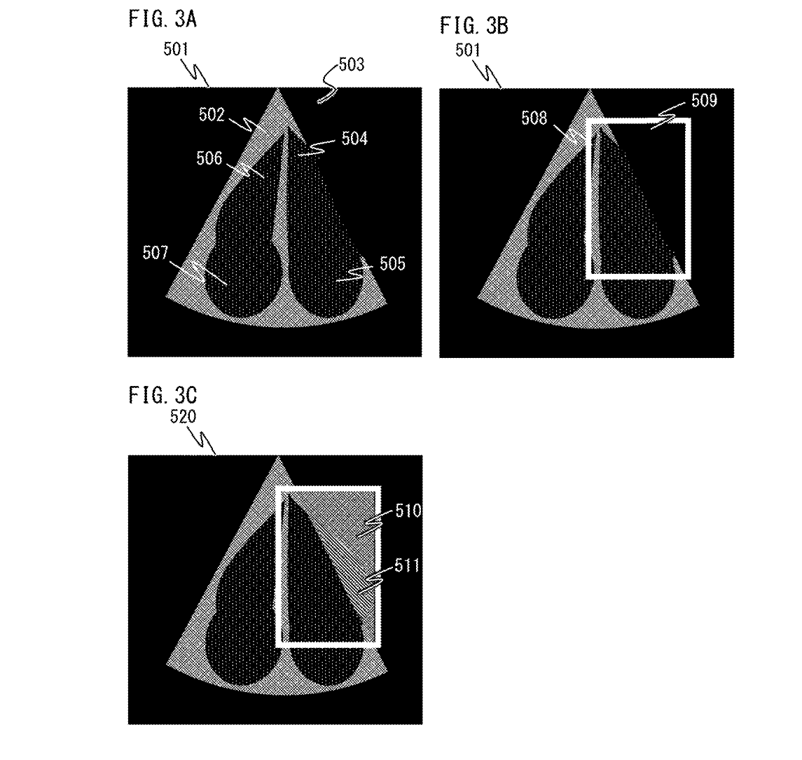

FIGS. 3A-3C are diagrams schematically showing an echocardiogram 501 that is a captured image of the heart of a subject and the left ventricle, the left atrium, the right ventricle, and the right atrium that are cardiac chambers rendered in the echocardiogram 501 as the input image according to the present embodiment. FIG. 3A shows a signal reconstruction region 502 in the echocardiogram 501 and a region 503 outside of the signal reconstruction region 502. In addition, the left ventricle 504, the left atrium 505, the right ventricle 506, and the right atrium 507 are shown in the echocardiogram 501. In FIG. 3A, the right ventricle 506, the right atrium 507, and the left atrium 505 are included within the signal reconstruction region 502 while a part of the left ventricle 504 extends into the region 503 outside of the signal reconstruction region 502.

FIG. 3B shows an object region 508 of complementary estimation processing that is determined by the region determining unit 43 through the processing of step S130 in the echocardiogram 501 or, in other words, a rectangular region where the left ventricle 504 is likely to exist. In addition, FIG. 3B shows a region 509 outside of the signal reconstruction region 502 in the object region 508.

(Step S140: Complementarily Estimate Region of Object 2) In step S140, the complementary estimation unit 44 complementarily estimates an image of a region outside the signal reconstruction region in the object region of the complementary estimation processing determined in step S130 using a learned model. Note that the control unit 40 may determine whether or not the object region of the complementary estimation processing includes a region outside of the signal reconstruction region and, if the object region does not include a region outside of the signal reconstruction region, the control unit 40 may omit processing of the present step.

In the present embodiment, the complementary estimation unit 44 executes complementary estimation processing with respect to an object image (image in white frame in FIG. 3B) obtained by cutting out the object region 508 determined in step S130 from the echocardiogram 501. More specifically, the complementary estimation unit 44 inputs the object image into the learned model and generates a complemented image that complements the region 509 outside of the signal reconstruction region 502 in the image. Therefore, the complementary estimation unit 44 generates the complemented image by inputting the input image to the learned model having been trained to receive an input image including an object corresponding to object 1 as input and output an image including at least a partial image of the object region. In addition, the complementary estimation unit 44 generates a complemented echocardiogram by replacing pixel values within the object region 508 in the input image with the complemented image. FIG. 3C shows an example of a complemented echocardiogram 520 generated using the complemented image generated by performing complementary estimation processing on the region 509.

FIG. 3C schematically shows a complemented image 510 generated by complementary estimation with respect to a region outside of the signal reconstruction region of the rectangular region and a region 511 complementarily estimated outside the signal reconstruction region with respect to the left ventricle 504. In the present embodiment, for example, a learned model that performs outpainting processing as described in Chenfei Wu, et al. “NUWA-Infinity: Autoregressive over Autoregressive Generation for Infinite Visual Synthesis” may be used as the learned model that performs complementary estimation. Outpainting processing is processing that uses information rendered in an image to plausibly complementarily estimate an image of a portion not rendered in the image. For example, when a part of an image is lost, the image of the defect region can be complementarily estimated so as to be consistent with the original image other than the defect region. In the present embodiment, the control unit 40 may display, in the display unit 36, the echocardiogram 520 generated using the complemented image 510 generated with respect to a region outside of the signal reconstruction region 502 of the left ventricle 504.

(Step S150: Estimate Information Regarding Object 2) In step S150, the processing unit 45 estimates information regarding object 2 using a learning model that receives the complemented image generated by complementary estimation in step S140 as input and estimates information regarding object 2.

In the present embodiment, a learned model is used which receives an echocardiogram generated using the complemented image of the rectangular region of the left ventricle complementarily estimated in step S140 (for example, the echocardiogram 520 in FIG. 3C) as input and which estimates a contour shape of the left ventricle. In this case, examples of information about the contour shape output from the learned model include coordinate values of a point cloud on the contour. In addition, a convolutional neural network (CNN) may be used as the learned model. Alternatively, a learned model trained by known methods such as regression using Vision Transformer, Random Forest, or AdaBoost may be used as the learned model.

While an image of a rectangular region of the left ventricle is input to the learning model in the present embodiment, an image of a wider region than the rectangular region (for example, the entire complementarily-estimated image) may be input to the learning model. While a contour shape of the left ventricle is estimated by the processing unit 45 using a learned model in the present embodiment, the processing unit 45 may calculate a region of the left ventricle using known image processing. Specifically, the processing unit 45 calculates the region of the left ventricle by performing known image processing such as graph cut using a region of the left ventricle calculated by applying a statistical shape model to the echocardiogram 520.

In addition, the processing unit 45 may execute image processing or analysis processing with respect to the complemented image. Accordingly, the processing unit 45 outputs medical information regarding the first anatomical site obtained based on complementary information. Examples of medical information regarding the first anatomical site include a contour of the anatomical site and index values of anatomical cardiac function. In addition, examples of the index values include left ventricular ejection fraction and global longitudinal strain (GLS). A specific example of image processing or analysis processing executed by the processing unit 45 will now be described. For example, after estimating the contour shape of the left ventricle, the processing unit 45 may superimpose the estimated contour shape of the left ventricle onto the input image. At this point, the processing unit 45 executes image processing of distinguishably displaying the estimated contour shape to be displayed in the object region of the complementary estimation and the estimated contour shape to be displayed on the input image. Specifically, the processing unit 45 executes image processing of displaying the estimated contour shape in the object region of the complementary estimation as a dashed line or a dotted line and displaying the estimated contour shape on the input image as a solid line. The estimated contour shape to be displayed in the object region of the complementary estimation is a site corresponding to a rendered region of the complemented image and the estimated contour shape to be displayed on the input image is a site corresponding to the defect region of the complemented image. In addition, the processing unit 45 may change the colors or thicknesses of the contour shapes relative to one another. Furthermore, the processing unit 45 may execute image processing of combining the display methods described above so that each contour shape is distinguishably displayed.

While it is assumed that the contour shape of the left ventricle is estimated with respect to a complemented image having been complementarily estimated in the present embodiment, the control unit 40 need not perform estimation processing of the contour shape and may display the complemented image having been complementarily estimated in step S140 on the display unit 36. Instead of or in addition to the above, the processing unit 45 may execute processing other than estimation processing of a contour shape (for example, estimation processing of image findings or anomaly detection processing of an image) with respect to the complemented image having been complementarily estimated in step S140. In addition, the processing unit 45 may perform image processing such as contrast conversion with respect to the complemented image having been complementarily estimated and the control unit 40 may display the image after the image processing on the display unit 36.

In addition, after estimating the contour shape of the left ventricle, the processing unit 45 may execute analysis processing of performing cardiac function measurement using the estimated contour shape of the left ventricle and generating measurement results. At this point, the processing unit 45 executes image processing of displaying the complementarily-estimated region and the estimated contour shape in distinguishable modes in an object site of the cardiac function measurement. Specifically, when measuring a volume of the left ventricle as the cardiac function measurement, the processing unit 45 reduces a contrast of the complementarily-estimated region of the left ventricle relative to the region of the left ventricle on the input image.

In this case, the processing unit 45 calculates the volume of the left ventricle using the Simpson method that is a known volumetric measurement method by superimposing cross-sections obtained by slicing cross-sections of an apical four-chamber view and an apical two-chamber view perpendicular to a long axis of the left ventricle. The apical four-chamber view is a cross-sectional view in which the apex of the heart is rendered directly beneath the probe position, allowing simultaneous observation of the left ventricle, the left atrium, the right ventricle, and the right atrium. In addition, the apical two-chamber view is a cross-sectional view in which the apex of the right ventricle is rendered directly beneath the probe position, with the left ventricle and the left atrium rendered in a positional relationship that is generally perpendicular to the apical four-chamber view. Furthermore, the long axis of the left ventricle refers to an axis connecting the apex of the left ventricle and the midpoint of the mitral annular ring.

In addition, the processing unit 45 executes image processing of displaying a cardiac function measurement value measured using the complementarily-estimated region of the left ventricle in a mode that is distinguishable from a cardiac function measurement value measured using a region on the input image. For example, when calculating volumes of the left ventricle and the right ventricle as cardiac function measurement values, the processing unit 45 executes image processing of displaying respective volume values of the left ventricle and the right ventricle in mutually different colors or displaying the volume value of the left ventricle measured using the complementarily-estimated region in a light text. Furthermore, the processing unit 45 may execute image processing of displaying an annotation next to the volume value of the left ventricle measured using the complementarily-estimated region. When performing a measurement using a complementarily-estimated region based on a measurement item of cardiac function measurement, the control unit 40 may toggle whether or not to perform a measurement or whether or not to display measurement values. Therefore, under the control by the control unit 40, the display unit 36 can toggle information regarding the outside of the signal reconstruction region or, in other words, toggle display and non-display of a site corresponding to the defect region of the complemented image in accordance with the type of processing executed by the control unit 40.

In addition, the use of a two-dimensional echocardiogram as the input image is assumed in the present embodiment. However, the input image is not limited to a two-dimensional echocardiogram and may be a three-dimensional echocardiogram. Specifically, the region determining unit 43 acquires a three-dimensional contour shape of the right ventricle that exists within the signal reconstruction region and, in a similar manner to step S130, determines a region where the left ventricle positioned adjacent to the right ventricle exists as a cuboid region based on the position of the contour of the right ventricle. Furthermore, the complementary estimation unit 44 receives a learned model with an image of the determined cuboid region as input to complementarily estimate an image outside of the signal reconstruction region in the cuboid region, and generates a complemented image.

In the image processing apparatus 10 according to the present embodiment, it is assumed that a single echocardiogram is used as an input image to complementarily estimate a region of the left ventricle from a contour shape of the right ventricle in the input image. However, the input image is not limited to a single image and may be, for example, a plurality of echocardiograms capturing a single cardiac cycle of a beating heart. In this case, in the series of ultrasonic images of a cardiac cycle capturing the heart, the signal reconstruction region is fixed to a predetermined region in the images. Furthermore, during the systole of the cardiac cycle, a large anatomical region fits within the signal reconstruction region, whereas during the diastole, a partial region of the left ventricle may be cut off outside the signal reconstruction region.

In this case, systole refers to a phase of the cardiac cycle during which the ventricles contract while diastole refers to a phase during which the ventricles relax. In images of the systole and the diastole, at least partial regions of the ventricles are rendered in both, enabling the control unit 40 to calculate a spatial relationship between the images. Therefore, the complementary estimation unit 44 can estimate a position and a shape of the left ventricle during the diastole using an image of the systole. Accordingly, the complementary estimation unit 44 calculates a rectangular region of the left ventricle during the diastole from the position of the left ventricle during the systole and performs complementary estimation of the rectangular region of the left ventricle existing outside the signal reconstruction region.

In addition, in the present embodiment, the complementary estimation unit 44 complementarily estimates a region outside the signal reconstruction region in step S140. However, the complementary estimation unit 44 may perform processing with respect to a complemented image to estimate a partial region of the complementarily-estimated rectangular region of the left ventricle with higher resolution than the image prior to the complementation and may update the complemented image using the estimated image. Specifically, the complementary estimation unit 44 inputs an image of a rectangular region in a vicinity of the mitral annulus in the complementarily-estimated rectangular region of the left ventricle to a learned model that performs estimations with higher accuracy than the image prior to the complementation and updates the complemented image with the output image of the rectangular region in the vicinity of the mitral annulus. In this manner, the complementary estimation unit 44 executes processing of acquiring a complemented image with respect to an object region including a portion outside of a rendered range as complementary information and elaborating the complemented image.

The processing of the image processing apparatus 10 in the present embodiment is executed through the processing steps described above. Accordingly, the image processing apparatus 10 can complementarily estimate a region of the left ventricle existing outside of the signal reconstruction region in an echocardiogram and accurately estimate a contour shape of the left ventricle. In addition, by determining a rectangular region where the left ventricle exists based on a contour shape of the right ventricle during the processing, the region of the left ventricle existing outside of the signal reconstruction region can be expected to be complementarily estimated with accuracy.

### Modification 1

Next, modification 1 of the present embodiment will be described. In the following description, the same reference signs will be used for components and processing similar to those of the first embodiment and detailed descriptions thereof will not be repeated.

While an echocardiogram captured by echocardiography is an object of complementary estimation processing in the first embodiment, in the present modification, ultrasonic images capturing areas other than the heart are objects of complementary estimation processing.

For example, in the image processing apparatus 10 according to the present modification, using an ultrasonic image of a fetus as an input image, the head region of the fetus that exists outside of the signal reconstruction region is complementarily estimated. Specifically, the input image acquiring unit 41 uses a learning model that estimates the abdominal region of the fetus with respect to an ultrasonic image capturing the fetus to acquire the abdominal region of the fetus as a mask image.

Next, using a shape model created by performing statistical analysis with respect to sample data of the abdominal and head regions of the fetus in a plurality of images, the region determining unit 43 determines a rectangular region likely to enclose the head region of the fetus as an object region based on the position of the abdominal region of the fetus. In addition, the complementary estimation unit 44 applies a learned model that performs complementary estimation on the obtained image of the object region to complementarily estimate the head region of the fetus.

As a result, according to the image processing apparatus 10 of the present modification, the head region of a fetus that exists outside of the signal reconstruction region can be complementarily estimated. In this manner, the present modification enables the present disclosure to be applied to cases where ultrasonic images capturing areas other than the heart are used.

### Modification 2

Next, modification 2 of the present embodiment will be described. In the following description, the same reference signs will be used for components and processing similar to those of the first embodiment and detailed descriptions thereof will not be repeated.

In the first embodiment, a region of the left ventricle existing outside the signal reconstruction region of an echocardiogram captured by echocardiography is complementarily estimated and the contour shape of the left ventricle is estimated from a complemented image generated by the complementary estimation. However, in the image processing apparatus according to the present modification, processing other than estimation processing of the contour shape of the left ventricle is executed as processing to be performed on a complemented image.

For example, the image processing apparatus 10 according to the present modification provides surgical support by aligning an echocardiogram captured by echocardiography during a surgery (an intraoperative echocardiogram) with a CT image of the heart captured prior to the surgery (a preoperative CT image). Specifically, a physician performing the surgery operates the image processing apparatus 10 and designates any region outside of the signal reconstruction region of the intraoperative echocardiogram based on a captured range of the preoperative CT image.

In addition, the complementary estimation unit 44 performs complementary estimation using a learned model that performs complementary estimation of the designated region and aligns the complementarily-estimated echocardiogram and the preoperative CT image. At this point, the complementary estimation unit 44 desirably lowers a contribution degree of the complementarily-estimated region compared to a region within the signal reconstruction region of the original echocardiogram when performing the positional alignment processing. In this case, a contribution degree refers to a degree to which a region affects the positional alignment of images, and a region with a higher contribution degree is preferentially used for the positional alignment. Accordingly, the contribution degree of a site corresponding to a defect region with respect to positional alignment processing becomes lower than the contribution degree of a site corresponding to a rendered region with respect to positional alignment processing. Furthermore, the complementary estimation unit 44 adjusts the intraoperative echocardiogram so that a region critical during surgery (for example, a puncture site) is included within the signal reconstruction region instead of being treated as a region to be subject to complementary estimation.

Therefore, the image processing apparatus 10 according to the present modification enables a preoperative CT image and an intraoperative echocardiogram which are images of a same object captured at different time points to be aligned. In addition, the image processing apparatus 10 according to the present modification enables accuracy of positional alignment between the preoperative CT image and the intraoperative echocardiogram to be improved by complementarily estimating a region outside the signal reconstruction region of the intraoperative echocardiogram in accordance with a range captured in the preoperative CT image.

### Modification 3

Next, modification 3 of the present embodiment will be described. In the following description, the same reference signs will be used for components and processing similar to those of the first embodiment and detailed descriptions thereof will not be repeated.

While an echocardiogram captured by echocardiography is an object of complementary estimation processing in the first embodiment, in the present modification, images acquired by other modalities are objects of complementary estimation processing.

An example of an image acquired by a modality that differs from that of the first embodiment to be an object of complementary estimation processing in the image processing apparatus 10 according to the present modification is a CT image showing an enlarged and reconstructed heart. Using the CT image as an input image, the image processing apparatus 10 uses a region of a right ventricle existing within a reconstructed region to complementarily estimate a region of the left ventricle that is cut off outside an enlarged and reconstructed region. Specifically, the input image acquiring unit 41 acquires a CT image capturing the heart as an input image. In addition, the object information acquiring unit 42 acquires information about the signal reconstruction region from a reconstruction diameter contained in supplementary information of a DICOM file of the acquired CT image.

Next, the region determining unit 43 acquires a region of the right ventricle included within the signal reconstruction region from the CT image, and determines a region where the left ventricle positioned adjacent to the acquired right ventricle is likely to exist as an object region of the complementary estimation processing. Specifically, the region determining unit 43 acquires a relationship between a size of a rectangular region enclosing the left ventricle and a size of a rectangular region enclosing the right ventricle as statistical information in advance, and determines a rectangular region where the left ventricle is likely to exist as an object region based on the acquired statistical information. Furthermore, the complementary estimation unit 44 receives a learned model with an image of the determined object region as input to complementarily estimate an image of the left ventricle cut off outside the signal reconstruction region in the object region, and generates a complemented image.

In addition, an example of executing the complementary estimation processing using an image other than a medical image in the image processing apparatus 10 is using an image of a person captured by a camera as an input image to complementarily estimate a part of the face of the person cut off from the captured range of the camera. Specifically, the input image acquiring unit 41 acquires a camera image capturing the face as an input image. In addition, the object information acquiring unit 42 acquires positions of the eyes, nose, mouth, and contour of the person included in the captured range from the acquired image. Next, based on the acquired positions of the eyes, nose, mouth, and contour of the person, the region determining unit 43 determines a region likely to encompass the entire face as an object region of complementary estimation processing. Specifically, the region determining unit 43 determines a rectangular region that is likely to encompass the entire face as the object region, using positions of the eyes, nose, mouth, and contour in the captured range as reference positions. Furthermore, the complementary estimation unit 44 receives a learned model with an image of the determined object region as input to complementarily estimate an image of the face cut off outside the signal reconstruction region in the object region, and generates a complemented image.

The image processing apparatus 10 according to the present modification can generate a complemented image in which an object outside a signal reconstruction region is accurately complementarily estimated even with respect to images generated by modalities other than a modality that generates echocardiograms as well as images capturing sites other than the heart.

### Modification 4

Next, modification 4 of the present embodiment will be described. In the following description, the same reference signs will be used for components and processing similar to those of the first embodiment and detailed descriptions thereof will not be repeated.

While cases where a region outside the signal reconstruction region is included in a part of an input image are assumed in the first embodiment, the present modification assumes a case where an entire input image is a signal reconstruction region.

In this case, in step S130, the region determining unit 43 determines a region of object 2 also including a region outside the input image as a rectangular region. In addition, in step S140, the complementary estimation unit 44 complementarily estimates the region also including the region outside the input image. Furthermore, the complementary estimation unit 44 expands the input image so as to include a region to be subjected to complementary estimation processing.

Accordingly, by defining the expanded region as a region outside the signal reconstruction region, the complementary estimation unit 44 can execute complementary estimation processing and generate a complemented image in a similar manner to the first embodiment. Therefore, the image processing apparatus 10 according to the present modification can generate a complemented image in which an object outside a signal reconstruction region is accurately complementarily estimated even when the input image does not include the outside of the signal reconstruction region.

### Second Embodiment

Next, an image processing apparatus according to a second embodiment will be described. In the following description, the same reference signs will be used for components and processing similar to those of the first embodiment and detailed descriptions thereof will not be repeated.

The image processing apparatus according to the present embodiment complementarily estimates, based on information regarding object 1 located within a signal reconstruction region in an input image, an image of an existence region where object 2 which extends outside of the signal reconstruction region and which differs from object 1 exists, in a similar manner to the first embodiment. Furthermore, the image processing apparatus according to the present embodiment estimates information regarding object 2 using the complemented image generated by the complementary estimation. The image processing apparatus 10 according to the first embodiment performs complementary estimation without subjecting a region of object 2 existing outside the signal reconstruction region to correction processing or the like. On the other hand, the image processing apparatus according to the present embodiment acquires information regarding object 2, corrects the region where object 2 exists based on the acquired information, and performs complementary estimation on an image of the corrected region.

The image processing apparatus according to the present embodiment uses an echocardiogram as an input image and acquires information regarding a contour of the right ventricle that exists within a signal reconstruction region in the input image in a similar manner to the first embodiment. In addition, the image processing apparatus complementarily estimates an image of the left ventricle of which at least a part exists outside the signal reconstruction region based on the acquired information, and generates a complemented image. Furthermore, the image processing apparatus estimates a contour of the left ventricle based on the complemented image.

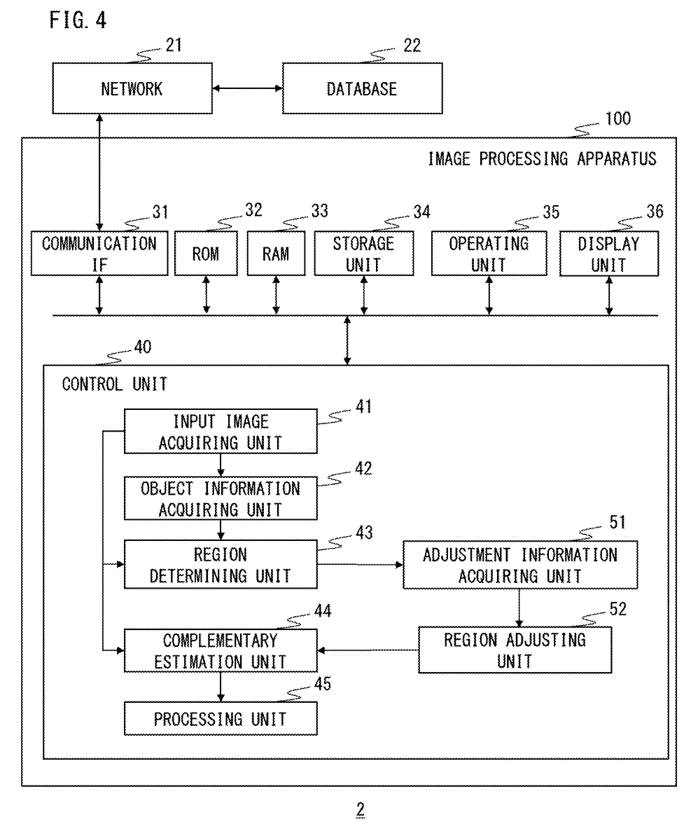

Hereinafter, a configuration and processing of an image processing apparatus 100 included in an image processing system 2 according to the present embodiment will be described with reference to FIG. 4. As shown in FIG. 4, the image processing system 2 includes the image processing apparatus 100 and the database 22. The image processing apparatus 100 according to the present embodiment differs from the image processing apparatus 10 according to the first embodiment shown in FIG. 1 in that the image processing apparatus 100 includes an adjustment information acquiring unit 51 and a region adjusting unit 52. Hereinafter, differences between respective processing units of the image processing apparatus 100 and those of the first embodiment will be described.

The adjustment information acquiring unit 51 acquires information regarding object 2 from the database 22 and/or the storage unit 34 as information for adjusting an existence region determined by the region determining unit 43 where object 2 exists. In addition, the region adjusting unit 52 adjusts, based on the information regarding object 2 acquired by the adjustment information acquiring unit 51, the existence region determined by the region determining unit 43 where object 2 exists or, in other words, an object region to be subjected to complementary estimation.

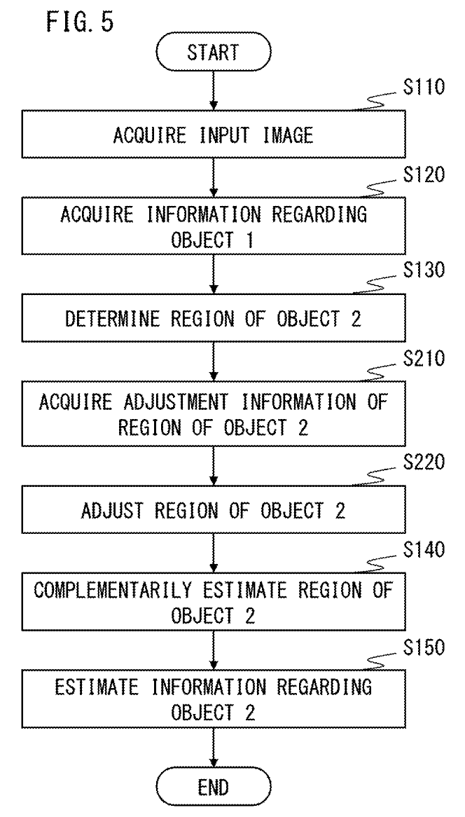

Next, an example of processing executed by the image processing apparatus 100 according to the present embodiment will be described in detail with reference to the flow chart in FIG. 5. The processing executed by the image processing apparatus 100 according to the present embodiment differs from the processing (FIG. 2) executed by the image processing apparatus 10 according to the first embodiment in that processing in step S210 of acquiring information for adjusting a region and processing in step S220 of adjusting the region are added. Hereinafter, differences between respective processing steps executed by the image processing apparatus 100 and processing contents in the first embodiment will be described.

(Step S210: Acquire Adjustment Information of Region of Object 2) In step S210, the adjustment information acquiring unit 51 acquires information (adjustment information) for adjusting the region of object 2 determined in step S130.

In the present embodiment, the adjustment information acquiring unit 51 acquires, as adjustment information, coordinates of positions of the apex and the mitral annular ring that exist within the signal reconstruction region as landmarks regarding the left ventricle (object 2) in the echocardiogram that is the input image. In this case, the apex of the left ventricle is positioned at an upper end of the left ventricle (an end in a direction opposing the left atrium) while the mitral annular ring is positioned at a lower end of the left ventricle (at a boundary between the left ventricle and the left atrium). In other words, in the present embodiment, coordinates of positions of upper and lower ends of the region of the left ventricle are acquired as information about a space where the left ventricle exists. The adjustment information acquiring unit 51 acquires coordinate information of positions of the apex of the left ventricle and the mitral annular ring by inputting the echocardiogram acquired in step S110 into the learned model.

Note that the adjustment information acquiring unit 51 may acquire coordinate information of positions of the apex of the left ventricle and the mitral annular ring by accepting manual input by the user of the image processing apparatus 100. However, when the apex and the mitral annular ring do not exist within the signal reconstruction region, the control unit 40 may execute processing of step S140 without executing the processing of steps S210 and S220.

Note that the adjustment information acquired by the adjustment information acquiring unit 51 may be information other than the coordinate information of positions of the apex of the left ventricle and the mitral annular ring. For example, the adjustment information acquiring unit 51 may acquire information about a contour of the left ventricle existing within the signal reconstruction region and acquire information about a width and/or a height of the left ventricle as adjustment information from the contour of the left ventricle existing within the signal reconstruction region.

In addition, the adjustment information acquired by the adjustment information acquiring unit 51 need not necessarily be information regarding the left ventricle that is object 2. For example, the adjustment information acquiring unit 51 may acquire information for adjusting the region determined in step S130, based on manual input by the user. Specifically, the adjustment information acquiring unit 51 acquires information such as a direction and a degree of adjustment in an image (for example, three pixels’ worth in the X-axis direction in an XY orthogonal coordinate system configured in the image) as information for adjusting the region of object 2.

(Step S220: Adjust Region of Object 2) In step S220, the region adjusting unit 52 adjusts the region of object 2 based on the adjustment information regarding object 2 for adjusting the region acquired in step S210.

The region adjusting unit 52 adjusts the region of the left ventricle determined in step S130 based on the coordinates of the positions of the apex of the left ventricle and the mitral annular ring acquired in step S210. Specifically, the region adjusting unit 52 adjusts positions of the upper and lower ends of the rectangular region of the left ventricle in the input image to positions of the apex and the mitral annular ring acquired in step S210, respectively. At this point, the region adjusting unit 52 may set end points of the rectangular region after adjustment to positions that ensure a certain margin from the positions of the apex and the mitral annular ring.

In addition, the image processing apparatus 100 according to the present embodiment complementarily estimates a region of the left ventricle existing outside of the signal reconstruction region by executing the processing of steps S130, S210, S220, and S140. However, the image processing apparatus 100 may execute the processing of steps S210, S220, and S140 after first executing the processing of steps S110, S120, S130, and S140 and complementarily estimating the region of the left ventricle. Specifically, the complementary estimation unit 44 complementarily estimates the region of the left ventricle by executing the processing described in the first embodiment and generates a complemented image. The region adjusting unit 52 adjusts a rectangular region enclosing the left ventricle using the generated complemented image. The complementary estimation unit 44 uses the adjusted rectangular region of the left ventricle to complementarily estimate a region outside of the signal reconstruction region, and generates a complemented image. Alternatively, the image processing apparatus 100 may be configured to repeatedly execute the sequence of processing in steps S210, S220, and S140 shown in FIG. 5.

As described above, since processing of the image processing apparatus 100 according to the present embodiment enables the object region of complementary estimation to be adjusted to a more appropriate position, the region of the left ventricle existing outside of the signal reconstruction region in the input image can be complementarily estimated with higher accuracy.

The technique disclosed herein may be embodied in various forms, such as systems, apparatuses, methods, programs, and recording media (storage media). Specifically, the technique disclosed herein may be applied to a system constituted of a plurality of devices (for example, a host computer, an interface device, an image capturing apparatus, and a web application) or to a system constituted of a single device.

It is needless to say that the object of the present disclosure can be achieved by doing as follows. Supply a recording medium (or storage medium) storing a program code (computer program) of software that realizes functions of the embodiments described above to a system or an apparatus. The recording medium is obviously a computer-readable recording medium. Then, have a computer (or a CPU or an MPU) of the system or the apparatus read and execute the program code stored in the recording medium. In this case, the recording medium storing the program code read from the recording medium is to constitute the technique according to the present disclosure.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

The technique according to the present disclosure can improve complementary accuracy of an object in an image in which a part of the object is cut off.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-083343, filed May 19, 2025, which is hereby incorporated by reference herein in its entirety.

What is claimed is:

1. A medical image processing apparatus, comprising:
a processor; and
a memory storing a program which, when executed by the processor, causes the medical image processing apparatus to
execute image acquisition processing of acquiring a medical image representing a first anatomical site, at least a part of which is outside of a rendered range, and
execute complementary information acquisition processing of acquiring complementary information with respect to an object region including a portion outside of the rendered range, based on information regarding a second anatomical site, a rendered position of which differs spatially or temporally from a rendered position of the first anatomical site.

2. The medical image processing apparatus according to claim 1, wherein in the complementary information acquisition processing, a region including a defect region corresponding to the portion outside of the rendered range and a rendered region corresponding to a portion of the medical image where the first anatomical site is rendered is set as the object region, and based on the information regarding the second anatomical site, a complemented image with respect to the set object region is acquired as the complementary information.

3. The medical image processing apparatus according to claim 2, wherein in the complementary information acquisition processing, a site corresponding to the rendered region in the complemented image and a site corresponding to the defect region in the complemented image are displayed in identifiable modes.

4. The medical image processing apparatus according to claim 2, wherein in the complementary information acquisition processing, toggling between display and non-display of a site corresponding to the defect region of the complemented image is implemented.

5. The medical image processing apparatus according to claim 1, wherein
the program, when executed by the processor, further causes the medical image processing apparatus to
execute output processing of outputting medical information regarding the first anatomical site obtained based on the complementary information.

6. The medical image processing apparatus according to claim 5, wherein in the output processing, a contour regarding the first anatomical site is output as the medical information.

7. The medical image processing apparatus according to claim 5, wherein in the output processing, an index value representing a function regarding the first anatomical site is output as the medical information.

8. The medical image processing apparatus according to claim 1, wherein in the complementary information acquisition processing, relationship information representing a spatial positional relationship between the second anatomical site and the first anatomical site is acquired as information regarding the second anatomical site, and, based on the relationship information, a region indicated by a rectangle including the defect region corresponding to the portion outside of the rendered range and the rendered region corresponding to the portion of the medical image where the first anatomical site is rendered is set as the object region.

9. The medical image processing apparatus according to claim 1, wherein in the complementary information acquisition processing, relationship information representing a temporal positional relationship between the second anatomical site and the first anatomical site is acquired as information regarding the second anatomical site, and, based on the relationship information, a region indicated by a rectangle including the defect region corresponding to the portion outside of the rendered range and the rendered region corresponding to the portion of the medical image where the first anatomical site is rendered is set as the object region.

10. The medical image processing apparatus according to claim 1, wherein in the complementary information acquisition processing, processing of acquiring as the complementary information a complemented image with respect to an object region including a portion outside of the rendered range and elaborating the complemented image is executed.

11. The medical image processing apparatus according to claim 1, wherein
the program, when executed by the processor, further causes the medical image processing apparatus to
execute region adjustment processing of adjusting the object region, and
in the complementary information acquisition processing, the complementary information is acquired based on a region adjusted by the region adjustment processing.

12. The medical image processing apparatus according to claim 2, wherein
in the complementary information acquisition processing, positional alignment processing between the medical image and an image that differs from the medical image is executed, and
in the positional alignment processing, a contribution degree of a site corresponding to the defect region with respect to the positional alignment processing is lower than a contribution degree of a site corresponding to the rendered region with respect to the positional alignment processing.

13. The medical image processing apparatus according to claim 12, wherein in the positional alignment processing, the medical image and the image that differs from the medical image are images of a same object captured at different time points.

14. The medical image processing apparatus according to claim 1, wherein the medical image is an image acquired using an ultrasonic diagnostic apparatus.

15. The medical image processing apparatus according to claim 1, wherein the medical image is a captured image of a heart of a subject, and the first anatomical site and the second anatomical site are mutually different cardiac chambers of the subject.

16. The medical image processing apparatus according to claim 1, wherein in the complementary information acquisition processing, by inputting the medical image into a learned model having been trained to receive an image as input and to output complementary information with respect to an object region including a portion outside of a rendered range of an anatomical site represented by the image, the complementary information with respect to the medical image is acquired from the learned model.

17. A medical image processing method, comprising:
acquiring a medical image representing a first anatomical site, at least a part of which is outside of a rendered range, and
acquiring complementary information with respect to an object region including a portion outside of the rendered range, based on information regarding a second anatomical site, a rendered position of which differs spatially or temporally from a rendered position of the first anatomical site.

18. A non-transitory computer readable medium that stores a program, wherein the program causes a computer to execute a control method of a medical image processing apparatus, the control method comprising:
acquiring a medical image representing a first anatomical site, at least a part of which is outside of a rendered range, and
acquiring complementary information with respect to an object region including a portion outside of the rendered range, based on information regarding a second anatomical site, a rendered position of which differs spatially or temporally from a rendered position of the first anatomical site.
